(19) United States
(12) Patent Application Publication
(10) Pub. No.: US 2026/0140957 A1
(43) Pub. Date: May 21, 2026

(54) SYSTEMS AND METHODS FOR SUMMARIZING CONTEXTUALLY RELEVANT INFORMATION ON USER-SELECTED CONCEPTS BASED ON RELATIONSHIPS OF USERS USING LANGUAGE MODELS WITH A DIVERGENT ARCHITECTURE

(71) Applicant: Capital One Services, LLC, McLean, VA (US)

(72) Inventors: Michael DAVIS, Arlington, VA (US); Galen RAFFERTY, Mahomet, IL (US); Taylor TURNER, Richmond, VA (US); Kenny BEAN, Herndon, VA (US)

(73) Assignee: Capital One Services, LLC, McLean, VA (US)

(21) Appl. No.: 18/949,913

(22) Filed: Nov. 15, 2024

(51) Int. Cl. G06F 16/2457; G06F 16/248; G06F 16/28; G06N 3/0475

(52) U.S. Cl. CPC G06F 16/24578; G06F 16/248; G06F 16/288; G06N 3/0475

(57) ABSTRACT

The systems and methods use a divergent artificial intelligence architecture. To summarize contextually relevant information on user-selected concepts despite the lack of adequate training data on each user, the system may use an architecture in which a first model is trained to map a plurality of user interactions to inputted concept identifiers to determine user relationship matrices whereas a second model is trained to generate contextually relevant summaries on inputted concepts and inputted user relationship matrices. For example, by using this divergent structure, the system does not need to be specifically trained to generate contextually relevant summaries based on each individual user's relationship to a given concept.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, the data that is obtained may need to be categorized and labeled accurately for a particular objective, which can be a difficult, time-consuming, manual task. Finally, results based on artificial intelligence can be difficult to review as the process by which the results are made may be unknown or obscured. This obscurity can create hurdles for identifying errors in the results, as well as improving the models providing the results, or applying results from a model trained for one objective for another. These technical problems may present an inherent problem with attempting to use an artificial intelligence-based solution in summarizing information specifically for a given user in which training data may be difficult to obtain.

### SUMMARY

Systems and methods are described herein for novel uses and/or improvements to artificial intelligence applications. As one example, systems and methods are described herein for summarizing information specifically for a given user for which training data may be difficult to obtain. For example, the system may summarize contextually relevant information on user-selected concepts based on the relationships of users using language models.

Summarizing contextually relevant information on user-selected concepts using language models is technically challenging using existing solutions due to several factors. First, users often have diverse and dynamic interests, making it hard for a model to accurately pinpoint the most relevant information for each individual. Additionally, language models rely on patterns in training data, which might not always align perfectly with the specific context or nuance a user is seeking. Understanding and maintaining context over a conversation or multiple interactions adds another layer of complexity, as the model must track and integrate various pieces of information accurately. Furthermore, summarization requires the model to balance brevity with completeness, ensuring that the core ideas are conveyed without omitting critical details. This task becomes even more difficult when dealing with intricate or specialized topics where depth and precision are crucial. Finally, the variability in human language, including synonyms, idioms, and different ways of expressing the same idea, challenges the model's ability to consistently interpret and condense information effectively.

In view of these technical challenges, the systems and methods use a divergent artificial intelligence architecture. Specifically, to summarize contextually relevant information on user-selected concepts, despite the lack of adequate training data on each user, the system may use an architecture in which a first model is trained to map a plurality of user interactions to inputted concept identifiers to determine user relationship matrices, whereas a second model is trained to generate contextually relevant summaries on inputted concepts and inputted user relationship matrices. For example, by using this divergent structure, the system does not need to be specifically trained to generate contextually relevant summaries based on each individual user's relationship to a given concept. Instead, the system may determine how mappings should relate to how contextually relevant summaries are generally generated. The system may then use a user's relationship matrix to a concept to determine how to modify a summary for a given concept, thus mitigating the need for user-specific and/or context-specific training data.

In some aspects, systems and methods for summarizing contextually relevant information on user-selected concepts based on the relationships of users using language models are described. For example, the system may receive, at a user interface, a first user query from a first user for a first contextually relevant summary of a first concept based on data from a first data store. The system may select a first concept identifier from a plurality of concept identifiers corresponding to the first concept. The system may, in response to selecting the first concept identifier, generate a first feature input for a first artificial intelligence model, wherein the first artificial intelligence model is trained to map a plurality of user interactions to inputted concept identifiers to determine user relationship matrices for the inputted concept identifiers. The system may input the first feature input into the first artificial intelligence model to generate a first output, wherein the first output comprises a first user relationship matrix for the first user and the first concept. The system may, in response to receiving the first user relationship matrix, generate a second feature input for a second artificial intelligence model based on the first concept and the first user relationship matrix, wherein the second artificial intelligence model is trained to generate contextually relevant summaries on inputted concepts and inputted user relationship matrices. The system may input the second feature input into the second artificial intelligence model to generate a second output, wherein the second output comprises the first contextually relevant summary of the first concept. The system may generate, for display in the user interface, the first contextually relevant summary.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative user interface for generating a summary, in accordance with one or more embodiments.

FIG. 2 shows an illustrative user interface comprising contextually relevant information on user-selected concepts based on the relationships of users, in accordance with one or more embodiments.

FIG. 3 shows illustrative components for a system used to generate contextually relevant information, in accordance with one or more embodiments.

FIG. 4 shows a flowchart of the steps involved in summarizing contextually relevant information, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Systems and methods described herein may use a divergent artificial intelligence architecture. For example, the system may use an architecture for a divergent artificial intelligence system that involves two main models working in conjunction. The first model is tasked with mapping a variety of user interactions to specific concept identifiers. Essentially, this model analyzes how users interact with different concepts (e.g., topics, ideas, and objects) and assigns these interactions to predefined categories or identifiers. By doing this, the model is able to construct user relationship matrices, which represent the connections or relations users have with these concepts based on their interactions.

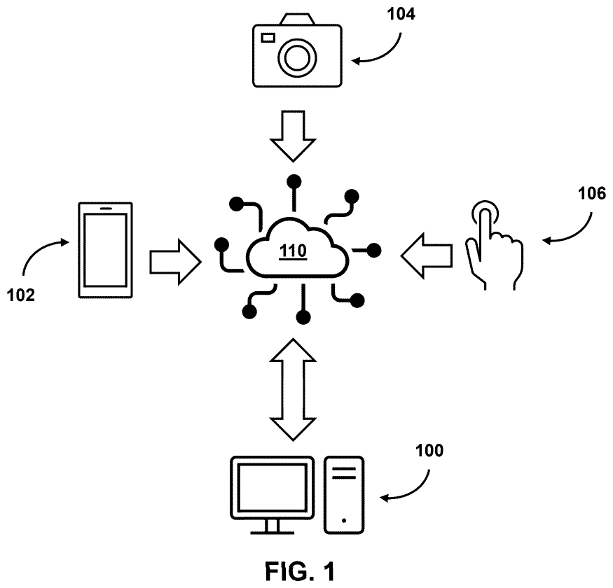

FIG. 1 shows an illustrative user interface for generating a summary, in accordance with one or more embodiments. For example, user interface 100 may indicate a user interface for summarizing contextually relevant information on user-selected concepts based on relationships of users using language models. For example, the first model may be trained to map a plurality of user interactions (e.g., on devices 102, 104, and 106) to one or more concept identifiers to determine user relationship matrices (e.g., matrix 110). As referred to herein, a “user interface” may comprise human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but it can also be part of a live performance. Furthermore, user-generated content may include content created and/or consumed by a user. For example, user-generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user or a customized desktop environment. In some embodiments, the user profile may be a digital representation of a person's identity. The data in the user profile may be generated based on the system's active or passive monitoring.

The user profile data and/or characteristic may be based on user interactions. As described herein, a user interaction with the user interface may refer to the myriad ways in which users engage with an application or website to navigate, input data, and/or receive feedback. These interactions are fundamental to the user experience and can include a wide range of actions, from simple to complex. Basic interactions may involve clicking, tapping, swiping, and scrolling—common gestures that allow users to traverse the digital environment. For example, clicking a button to submit a form or swiping left or right on a touchscreen device to navigate through a carousel of images. More advanced interactions may include drag-and-drop operations, pinch-to-zoom gestures on touchscreens, and the use of keyboard shortcuts for more efficient navigation. Beyond these mechanical interactions, users also interact with the user interface through forms and fields, where they input data such as text, selections from drop-down menus, or toggling settings. The system may also monitor how users interact with the feedback the user interface provides. This can be in the form of visual cues, like animations and transitions that confirm an action has been taken, auditory feedback; like sounds indicating success or error; or even haptic feedback on mobile devices, which gives physical sensations to inform user actions. User interactions may also extend to less direct elements, such as how users perceive the layout and design of the user interface, including color schemes, typography, and overall aesthetics. These elements can influence the ease and pleasure of the user experience, affecting how efficiently and effectively users can achieve their goals within the application or website.

In some embodiments, a concept may refer to an abstract idea or a fundamental principle that underpins the design and functionality of an application. Concepts in software development can range from high-level architectural patterns and design principles to specific methodologies or technologies used to build and maintain the software. For example, a concept might be the use of “object-oriented programming” (OOP) as a foundational approach for structuring code, where data and functions are encapsulated into objects. Another concept could be “responsive design,” which guides the development of applications that automatically adjust their layout to provide an optimal viewing experience across a variety of devices, from desktops to mobile phones. Concepts can also encompass more specific elements, such as “agile development practices,” which emphasize iterative progress through short development cycles (sprints), collaboration, and adaptability throughout the life of a project. Additionally, a concept might involve the implementation of a particular technology stack or framework, such as using the React library in web development to facilitate the creation of interactive user interfaces. For example, one example may be where the concept is a project that a team at a company has been working on for six months. When leadership changes and a new director comes in to oversee, not only this project but multiple other projects as well, the new director needs to be brought up to speed quickly to make important decisions about the direction of the project. This system may appropriately distill the context of the project to the level necessary for this director to be up to speed and ready to make decisions.

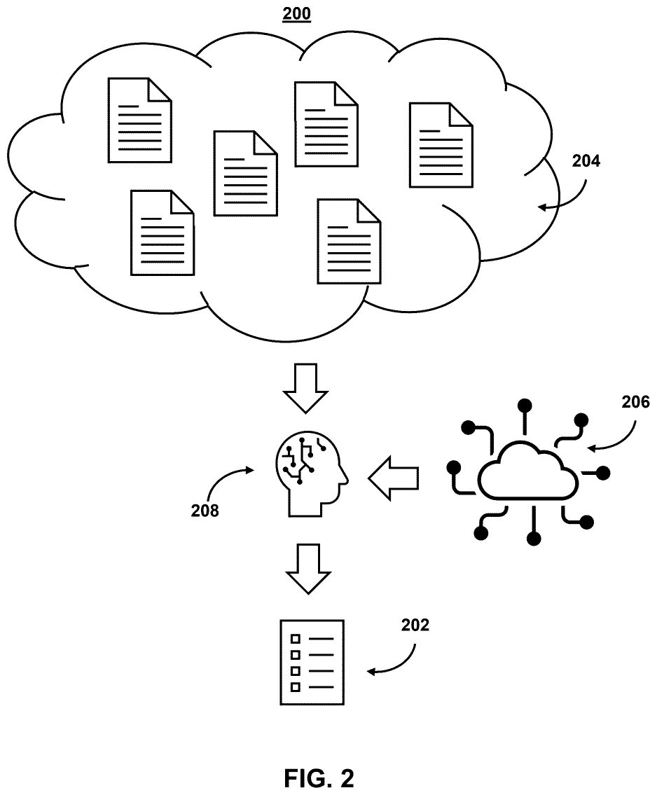

In some embodiments, the system may receive, at user interface 202, a first user query from a first user for a first contextually relevant summary of a first concept based on data from a first data store (e.g., knowledge base 204 (FIG. 2)). The system may select a first concept identifier from a plurality of concept identifiers corresponding to the first concept. In response to selecting the first concept identifier, the system may generate a first feature input for a first artificial intelligence model (e.g., model 208), wherein the first artificial intelligence model is trained to map a plurality of user interactions to inputted concept identifiers to determine user relationship matrices for the inputted concept identifiers.

As described herein, a concept identifier may be a word, title, tag, and/or label used to categorize and reference specific concepts (and/or distinguish one concept from another). This process may be manual, automated, or a combination of both, depending on the complexity of the system and the accuracy required. In a manual setup, users (or a system) may assign tags or labels to content based on their understanding of the topic. This could involve selecting appropriate concept identifiers from a predefined list when uploading documents or creating content. For instance, a journalist might tag a news article with identifiers such as “Politics,” “Economy,” or “International Relations” based on the content. Automated systems, on the other hand, use natural language processing (NLP) and machine learning algorithms to analyze the text and associate it with relevant concept identifiers. These systems scan the content for keywords, phrases, and contextual clues. For example, an automated tagging system might recognize words like “election” or “parliament” in a text and link these to the “Politics” concept identifier. Hybrid systems combine both methods, where initial tags are suggested by an automated system, and users can then review and adjust these tags to ensure accuracy and relevance. This approach leverages the efficiency of automation while maintaining the accuracy that human oversight provides.

Matrix 110 may comprise a user relationship matrix. A user relationship matrix, in the context of a user and a concept, may be a structured representation that captures the interactions and relationships a user has with a specific concept. This matrix may be constructed by analyzing various interactions that occur over time between the user and the concept within a software application or system. Each entry in the matrix quantifies the strength, frequency, type, or quality of these interactions, thereby providing a multi-dimensional view of the user's engagement with the concept. For example, if the concept is a particular product in an online store, the matrix might include data points such as the number of times the user has viewed the product, added it to their cart, purchased it, or even reviewed it. Each of these actions contributes to a more comprehensive understanding of how the user relates to that product concept. The matrix could use numerical values, categorical labels, or even a weighted system to differentiate between types of interactions and their significance. The primary purpose of the user relationship matrix may be to enable more personalized and effective responses within the system. By leveraging this matrix, algorithms can predict user preferences, recommend new concepts (such as products or content), and customize user experiences based on past interactions. In contexts like e-commerce, education, or content delivery platforms, such matrices are invaluable for enhancing user satisfaction and engagement, ultimately driving better outcomes for both users and providers. The use of these matrices represents a sophisticated approach to capturing and utilizing user data to refine the interaction dynamics between users and concepts.

Recording a user relationship matrix in a database can be approached differently depending on the database system used—be it relational, NoSQL, or graph databases—each is tailored to optimally store and manage the complex relationships between users and concepts. For example, in a relational database, the matrix is typically stored across several tables. A Users Table includes user identifiers and information, while a Concepts Table catalogs each concept with identifiers and details. The pivotal Interactions Table links users and concepts, detailing each interaction through records that include user ID, concept ID, interaction type, and a score or weight to quantify the interaction. This table effectively represents the matrix, with each row signifying the relationship's strength or frequency for a specific user-concept pair.

The system may use NoSQL databases, like MongoDB, and provide a more flexible schema that can directly embed interaction data within documents. For example, each user document may contain embedded sub-documents for each concept interaction, detailing interaction types and metrics. Similarly, concept documents might store details about interactions from various users, facilitating a dynamic and schema-less organization of user interactions.

The system may use graph databases, such as Neo4j, naturally excel at representing relationships and are particularly intuitive for storing user relationship matrices. In this setup, user nodes and concept nodes are linked directly by edges, which are used to represent relationships. These edges are annotated with properties that describe the interactions, such as type and strength, allowing for a direct and visually logical representation of relationships.

FIG. 2 shows an illustrative user interface comprising contextually relevant information on user-selected concepts based on the relationships of users, in accordance with one or more embodiments. For example, system 200 may show a model (e.g., model 208) trained to generate contextually relevant summaries based on a knowledge base (e.g., knowledge base 204) related to one or more inputted concepts and a user relationship matrix (e.g., matrix 206). For example, the system may generate contextually relevant summaries of content. The content may cover a wide range of use cases, such as in the classroom, at the office, integrated into search engines, etc. For example, the system may include a knowledge source that is queried by a user. The user specifies the concept for which they wish to have context. A relationship between the concept and the user is established and defined, and then the knowledge source provides appropriately distilled context on the concept to the user based on how the relationship is defined.

As described herein, a contextually relevant summary may be a condensed version of content that is specifically tailored to align with the interests, needs, and/or circumstances of its intended audience. This type of summary may go beyond merely extracting the main points of a document or conversation; it may actively consider the context in which the summary will be read or used. This context can include factors like the user's previous interactions, current environmental conditions, the presence of specific keywords, the user's location, or even time-sensitive elements. For instance, in a business setting, a contextually relevant summary for a quarterly financial report might highlight information that is crucial for an upcoming board meeting, emphasizing data trends that are significant to the strategic decisions at hand. In a more personal use case, a contextually relevant summary of a news article might focus on aspects of the story that relate to the reader's past interests or geographical location. The effectiveness of a contextually relevant summary lies in its ability to provide information that is not just accurate but also highly applicable to the user's current situation or decisions. This tailored approach helps make the summary more engaging and useful, increasing the likelihood that the information will be retained and acted upon by the user. Such summaries are particularly valuable in fields like personalized learning, where content needs to be adapted to individual learning styles and knowledge gaps, or in targeted marketing, where messages must resonate with specific consumer demographics or behaviors.

For example, by using the divergent structure, the system does not need to be specifically trained to generate contextually relevant summaries based on each individual user's relationship to a given concept. Instead, the system may determine how mappings should relate to how contextually relevant summaries are generally generated. The system may then use a user's relationship matrix to a concept to determine how to modify a summary for a given concept, thus mitigating the need for user-specific and/or context-specific training data.

As referred to herein, knowledge base 204 may comprise any data store, database, and/or other component. In some embodiments, the knowledge source can be, but is not limited to, a large language model (LLM) that serves as the source of truth for one or many concepts. This model can be trained on text such as enterprise confluence pages, which host the in-depth documentation for all the projects, Internet sources, curriculum text books, etc. The user can be anyone who needs to learn more about a specific topic, such as onboarding engineers or leadership who need to quickly know different levels of context to do their job, and additionally, students learning at any level of education. The relationship can be defined in different ways. For example, there may be an enterprise directory to inform the system how the user relates to the concept they are asking about. Alternatively, the system could ask essential questions to clear up ambiguity about its understanding of the user's relationship to the concept. The context provided by the knowledge source is specifically tailored to the user based on what they need to know and the level of detail required to perform their task. A director will get a different explanation about a project than an engineer would.

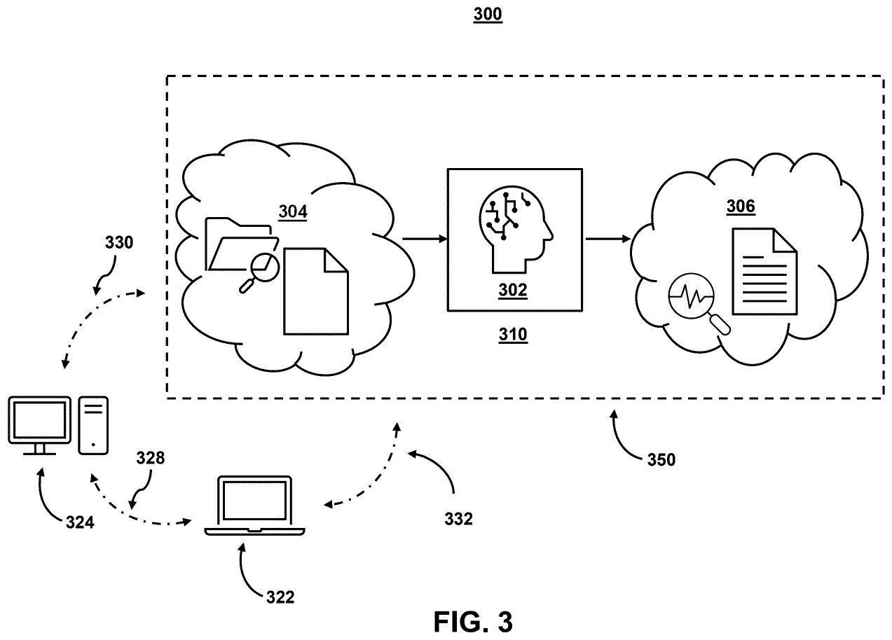

FIG. 3 shows illustrative components for a system used to generate contextually relevant information, in accordance with one or more embodiments. For example, FIG. 3 may show illustrative components for summarizing contextually relevant information on user-selected concepts based on relationships of users using language models. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., user relationship matrices, contextually relevant summaries, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., user relationship matrices, contextually relevant summaries, etc.).

In some embodiments, the model (e.g., model 302) may automatically perform actions based on outputs 306. In some embodiments, the model (e.g., model 302) may not perform any actions. The output of the model (e.g., model 302) may be used to summarize contextually relevant information on user-selected concepts based on relationships of users using language models.

Model 302 may use a divergent architecture. For example, to summarize contextually relevant information on user-selected concepts despite the lack of adequate training data on each user, the system may use an architecture in which a first model is trained to map a plurality of user interactions to inputted concept identifiers to determine user relationship matrices, whereas a second model is trained to generate contextually relevant summaries on inputted concepts and inputted user relationship matrices. For example, by using this divergent structure, the system does not need to be specifically trained to generate contextually relevant summaries based on each individual user's relationship to a given concept. Instead, the system may determine how mappings should relate to how contextually relevant summaries are generated generally. The system may then use a user's relationship matrix to a concept to determine how to modify a summary for a given concept; thus, mitigating the need for user-specific and/or context-specific training data.

The first artificial intelligence model may be trained to map a plurality of user interactions to inputted concept identifiers to determine user relationship matrices for the inputted concept identifiers by retrieving a plurality of user interaction reports corresponding to the plurality of user interactions, iteratively parsing the plurality of user interaction reports for the first concept identifier to determine one or more relationships between the first user and the first concept, and weighting each of the one or more relationships based on detected characteristics.

For example, the system may gather a wide array of user interaction reports. These reports detail how users interact with various concepts across a platform—whether through clicks, views, purchases, likes, comments, or other forms of engagement (e.g., as described in FIG. 1). Each interaction is potentially linked to one or more concept identifiers, which categorize the content or items users interact with. Once these reports are collected, the system begins the process of parsing them. This step may involve iteratively analyzing the reports to extract meaningful patterns or relationships specific to individual users and concepts. For instance, the system might analyze how frequently a user views articles related to a particular concept identifier like “sustainable energy.” This parsing is not only count interactions, but also involves understanding the context and depth of interactions based on the content's nature and the user's engagement level. Following the parsing phase, the system may employ algorithms to determine the relationships between users and concepts. It's here that the model considers various detected characteristics of the interactions, such as frequency, duration, recency, and sentiment. Each of these characteristics might be weighted differently, depending on their relevance to the concept and their indicative value of user interest or engagement. For example, recent interactions might be given more weight than older ones, or longer, more in-depth reads might be considered more significant than brief views. These weighted interactions are then used to build or update the user relationship matrices. Each matrix entry reflects the strength and nature of the relationship between a user and a concept, informed by the weighted characteristics of their interactions. The final matrix not only represents a static snapshot but can dynamically evolve as new data comes in and as user behaviors change over time.

For example, a model may be trained to generate contextually relevant summaries on inputted concepts and inputted user relationship matrices by retrieving a plurality of historical concepts, retrieving a language model trained to generate summaries of the plurality of historical concepts in the first data store and re-training the language model to modify the summaries to generate the contextually relevant summaries based on the inputted user relationship matrices. For example, the system may begin with the retrieval of a vast array of historical concepts from a dedicated data store (e.g., knowledge base 204 (FIG. 2)). These historical concepts provide a foundational dataset that reflects a wide range of information and user interactions over time. The significance of this step lies in the diversity and depth of data available, which can include previous summaries, related content, user feedback, and more. Simultaneously, the system may access a language model that has been previously trained to generate summaries for these historical concepts. This language model, typically based on advanced machine learning techniques such as deep learning or neural networks, is capable of understanding and summarizing complex information accurately. The core of the customization process may involve re-training or fine-tuning this pre-trained language model using the specific user relationship matrices that have been inputted. These matrices encapsulate detailed insights into how different users relate to various concepts, based on their historical interactions. By integrating this user-specific data, the language model can adjust its summarization patterns. For instance, it might emphasize or prioritize certain aspects of a concept more heavily in the summary if those aspects have historically resonated more with a given user or user group.

During re-training, the model may adjust its parameters to better align the summaries with the nuances and preferences captured in the user relationship matrices. This could involve altering sentence structure, choosing more relevant details, or even adapting the tone of the summary to better engage the specific audience. This refined, re-trained model may be then used to generate summaries that are not only accurate concerning the concept content but also highly personalized based on the detailed relationship data provided. The result may be a set of summaries that are significantly more relevant and useful to the users, enhancing their engagement and satisfaction with the content. This process leverages the power of machine learning to deliver a dynamically adaptive content experience that is tailored to individual user profiles and interests.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

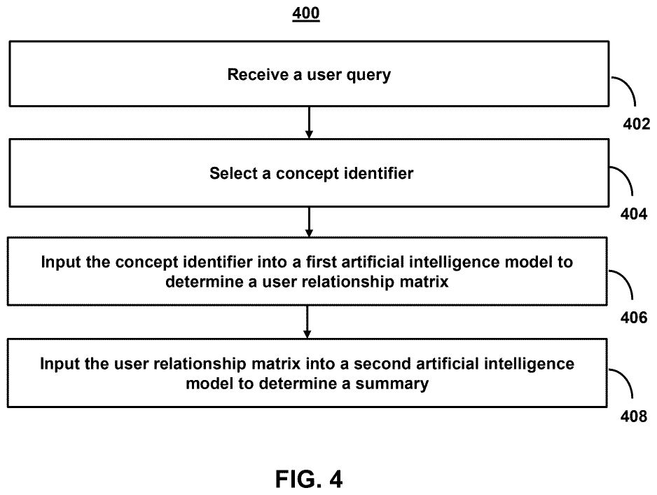

FIG. 4 shows a flowchart of the steps involved in summarizing contextually relevant information, in accordance with one or more embodiments. For example, the system may use process 400 (e.g., as implemented on one or more system components described above) in order to summarize contextually relevant information on user-selected concepts based on relationships of users using language models.

At step 402, process 400 (e.g., using one or more components described above) receives a user query. For example, the system may receive, at a user interface, a first user query from a first user for a first contextually relevant summary of a first concept based on data from a first data store. When a first user approaches the user interface, which could be a web-based platform, a mobile application, or any digital interface, the user may input a query seeking a summary of a specific concept. This query might be entered through typing, voice commands, or even selecting options from a menu, depending on the sophistication of the interface. Upon receiving this query, the system first identifies the user, which may involve authentication to ensure personalized and secure access. The system then interprets the user's input to discern the particular concept for which the summary is requested.

At step 404, process 400 (e.g., using one or more components described above) selects a concept identifier. For example, the system may select a first concept identifier from a plurality of concept identifiers corresponding to the first concept. In some embodiments, the system may parse the query to extract keywords or phrases that clearly identify a concept. For example, the system may interact with a first data store, which houses a repository of data related to various concepts, including historical user interactions, previous summaries, and possibly metadata about the concepts.

In some embodiments, when a system receives an input, such as a query or a specific term, from a user, it first parses this input to understand and identify the underlying concept being referred to. This parsing stage may involve natural language processing (NLP) techniques to extract key terms, phrases, and their semantic meanings from the user's input. Following this, the system consults its database, where multiple concept identifiers are stored. Each identifier is associated with a concept, and these identifiers encapsulate various aspects or dimensions of the concept, often reflecting different interpretations or contexts in which the concept can be understood.

The selection of the most appropriate concept identifier from the available set is driven by a combination of relevance to the user's input and contextual data about the user's preferences or historical interactions, if available. The system uses algorithms, potentially enhanced by machine learning, to match the parsed query with the concept identifiers in its database, assessing which identifier best aligns with the semantic intent of the user's query. Additionally, the system may consider the context in which the query was made—such as the user's location, time, previous interactions with related concepts, or even the application's specific use case—to refine its selection of the concept identifier. This ensures that the chosen identifier not only matches the literal terms of the query but also resonates with the broader context or specific needs of the user at that moment.

At step 406, process 400 (e.g., using one or more components described above) inputs the concept identifier into a first artificial intelligence model to determine a user relationship matrix. For example, the system may, in response to selecting the first concept identifier, generate a first feature input for a first artificial intelligence model, wherein the first artificial intelligence model is trained to map a plurality of user interactions to inputted concept identifiers to determine user relationship matrices for the inputted concept identifiers. The system may input the first feature input into the first artificial intelligence model to generate a first output, wherein the first output comprises a first user relationship matrix for the first user and the first concept.

Once the system selects the first concept identifier, it proceeds to gather and prepare the necessary data to create the first feature input for the model. This involves compiling a comprehensive set of user interaction data related to the chosen concept. This data may include variables such as the frequency, duration, and nature of interactions the user has had with the concept, as well as contextual information like the time and setting of these interactions. Additional metadata from the user's profile, such as demographic details, past behaviors, and preferences, may also be included to enrich the feature set. The feature input is carefully structured to align with the requirements of the AI model. This structuring might involve normalizing the data to ensure consistency, encoding categorical variables, and handling any missing or outlier values to maintain the quality and reliability of the input data. The aim is to create a robust and informative feature vector that accurately represents the user's engagement with the concept.

Upon creating this feature input, it is then fed into the first artificial intelligence model. This model has been previously trained on a diverse dataset to understand and predict the relationships between users and concept identifiers. The training would have involved learning from a vast array of user interactions, allowing the model to discern patterns and correlations that define user relationships with concepts. When the feature input is entered into the model, the model processes it using its learned parameters to generate an output. This output is a user relationship matrix for the first user concerning the first concept. The matrix typically quantifies the strength and dimensions of the user's relationship with the concept, such as interest level, engagement intensity, and preference nuances.

Additionally or alternatively, a data store may also contain user relationship matrices (as opposed to determining one upon receiving a query) that detail how different users have interacted with these concepts over time, offering insights into user preferences and behaviors. The system uses this rich dataset to generate a summary that is not only pertinent to the requested concept but also tailored to the specific user's historical interactions and preferences as recorded in the user relationship matrix.

In some embodiments, the first artificial intelligence model may be trained to map the plurality of user interactions to the inputted concept identifiers to determine the user relationship matrices for the inputted concept identifiers by determining the characteristics of the one or more relationships and weighting each of the one or more relationships based on the characteristics. The system may determine the characteristics of one or more relationships and use this information to generate the user relationship matrix. For example, the system may determine the respective strengths of one or more relationships and determine their respective characteristics based on the respective strengths. In another example, the system may determine the respective frequencies of one or more relationships and determine their respective characteristics based on the respective frequencies. In another example, the system may determine the respective uniqueness of each of the one or more relationships and determine their respective characteristics based on the respective uniqueness of each of the one or more relationships.

For example, the system may collect detailed data on user interactions with various concepts. This data includes not only the types and frequencies of interactions but also additional context such as timing, duration, and user feedback. Each interaction type, whether it is viewing, commenting, liking, or purchasing, provides insight into how users relate to different concepts. Once this data is aggregated, the system begins to analyze it to identify and determine the characteristics of the relationships between users and concepts. For example, the system may assess the strength of a relationship by analyzing how frequently a user engages with a concept. A higher frequency of interactions, especially over a sustained period, might indicate a strong relationship. Similarly, the system can evaluate the uniqueness of a relationship by determining how distinct a user's interactions with a concept are compared to interactions with other concepts, or compared to other users'interactions with the same concept. Each of these characteristics—strength, frequency, and uniqueness—is then used to weight the relationships in the user relationship matrix. The weighting process is crucial as it quantifies the significance of each relationship, allowing the model to prioritize or emphasize certain relationships over others. For instance, a relationship characterized by high frequency and uniqueness might receive a higher weight, signaling a deeper or more exclusive engagement with the concept. The training of the model involves using these weighted relationships to adjust the model's parameters. This could be done through supervised learning techniques, where the model learns to predict user preferences and behaviors based on historical data of weighted user interactions. The objective is to enable the model to not only recreate the observed user relationship matrices but also to predict future interactions and preferences.

In some embodiments, the system may generate the first output further by determining a plurality of relationships between the first set of user interactions of the first user and the first concept identifier and generating the first user relationship matrix for the first user based on the plurality of relationships. For example, the system may generate the user relationship matrix, a comprehensive representation of the multiple dimensions of the user's interactions with the concept. This matrix not only summarizes the user's past and current engagement but also serves as a predictive tool for future interactions and preferences. Moreover, the system may determine a plurality of weights between the first set of user interactions of the first user and the first concept identifier and generate the first user relationship matrix for the first user based on the plurality of weights. For example, the system captures and categorizes a variety of interactions that the first user has with the concept associated with the first concept identifier. These interactions could include various behaviors, such as clicking links, viewing pages, commenting, or purchasing products related to the concept. Each type of interaction is recorded and analyzed to assess its significance and relevance to the user's engagement with the concept. Once the system has assigned weights to the various interactions based on these factors, it uses these weighted interactions to construct the user relationship matrix. Each entry in the matrix represents a quantified value that reflects the strength and nature of the relationship between the user and the concept, based on the weighted interactions.

In some embodiments, the system may determine a modification to the plurality of user interactions mapped to the inputted concept identifiers based on the first output and re-train the first artificial intelligence model based on the modification. For example, the system may generate a first output, typically a user relationship matrix or a set of predictions about user preferences and behaviors, which is based on the original mapping of user interactions to concept identifiers. This output provides a snapshot of how well the current model understands and predicts the relationships between users and concepts. The system may then analyze this first output to identify discrepancies or areas for improvement—such as unexpected patterns, inaccuracies in user preference predictions, or overlooked interactions that might affect the model's performance. This analysis often involves comparing the model's predictions or classifications against real user feedback or updated interaction data to spot misalignments or gaps.

Based on this analysis, the system may determine necessary modifications to the mapping of user interactions to concept identifiers. These modifications could involve adjusting the weights assigned to different types of interactions, reclassifying certain interactions under more appropriate concept identifiers, or incorporating previously unconsidered interactions that have shown significance in the user relationship matrix.

In some embodiments, the plurality of user interactions mapped to the inputted concept identifiers comprises a list of database links between the plurality of user interactions and the plurality of concept identifiers corresponding to the first concept. The system may determine a new database link based on the first output and update the list to include the new link. The system starts by collecting data on user interactions, which could include actions such as clicks, views, likes, searches, or purchases related to specific concepts. Each interaction is tagged with an associated concept identifier that categorizes the interaction according to the relevant concept. To manage these associations, the system utilizes a list of database links. Each link in this list represents a connection between a particular user interaction and a concept identifier, effectively mapping each interaction to its corresponding concept.

These links are stored in the database, facilitating quick retrieval and analysis of interaction data based on concept identifiers. This setup not only helps in organizing the data efficiently but also enables complex queries and analytics, such as aggregating all interactions related to a specific concept or tracking changes in interaction patterns over time. When the system generates an output —such as a user relationship matrix or another form of analysis—it may reveal new insights into how users interact with concepts. For example, the output might indicate a previously unrecognized correlation or a new pattern of user behavior concerning certain concepts. Based on these insights, the system might identify the need to create a new database link. This new link would represent a newly discovered or revised connection between a user interaction and a concept identifier, which had not been adequately captured by the existing links.

Once this new link is determined, the system updates its list of database links to include the new connection. This update might involve adding a new entry to the list, modifying an existing link, or even reorganizing several links to better reflect the latest understanding of user-concept interactions. The updated list helps ensure that the database remains current and accurately reflects the true nature of user interactions with concepts, allowing for more precise analytics and better-informed decision-making in subsequent operations.

At step 408, process 400 (e.g., using one or more components described above) inputs the user relationship matrix into a second artificial intelligence model to determine a summary. For example, the system may, in response to receiving the first user relationship matrix, generate a second feature input for a second artificial intelligence model based on the first concept and the first user relationship matrix, wherein the second artificial intelligence model is trained to generate contextually relevant summaries on inputted concepts and inputted user relationship matrices. The system may input the second feature input into the second artificial intelligence model to generate a second output, wherein the second output comprises the first contextually relevant summary of the first concept. The system may then generate, for display in the user interface, the first contextually relevant summary.

For example, upon receiving the first user relationship matrix, the system may generate a second feature input that incorporates both the selected first concept and the insights gleaned from the user relationship matrix. This matrix, which details the user's interactions and affinity towards the concept, is instrumental in personalizing the summary. The second feature input encapsulates not just the static data about the concept—such as key attributes, historical data, or general descriptions—but also dynamic user-specific data, such as interaction frequencies, preferred content types, and engagement depth. This feature input is carefully crafted to ensure it provides a holistic view of both the concept and the user's relationship with it. This enriched second feature input is then fed into a second artificial intelligence model, which has been specifically trained to generate contextually relevant summaries based on the inputted concepts and user relationship matrices. The training of this model would involve learning from a vast dataset of concept summaries, user interactions, and corresponding outputs that are tuned to maximize relevance and engagement based on user-specific matrices. The model processes the second feature input using its trained algorithms and outputs a contextually relevant summary. This summary is tailored to the user's demonstrated preferences and interaction patterns with the concept, ensuring that the content is not only informative but also aligns closely with the user's interests and prior engagements. Finally, the system prepares this summary for display on the user interface. The summary is formatted and perhaps even embellished with relevant visual aids or interactive elements to enhance comprehension and engagement. When displayed, the summary provides the user with a concise, personalized overview of the concept that is directly informed by their unique relationship matrix, thereby enhancing the user experience through personalized content that is both relevant and timely.

In some embodiments, the system may train a second artificial intelligence model to generate contextually relevant summaries of the inputted concepts and the inputted user relationship matrices by retrieving a plurality of historical concepts and retrieving a first language model trained to generate summaries of the plurality of historical concepts in the first data store. For example, the system may retrieve a rich set of historical concepts from a first data store. This dataset comprises diverse and extensive content related to various concepts that have been previously summarized, providing a foundational corpus for training. The variety in the historical concepts helps to ensure that the model learns to handle a wide range of topics and contexts, which is crucial for generating accurate and comprehensive summaries. Simultaneously, the system retrieves a first language model that has been pre-trained to generate summaries of these historical concepts. This model, typically based on advanced neural network architectures such as transformers, has already learned how to condense information into concise summaries from its previous training on a broad array of topics. The system may retrain or fine-tune this pre-existing language model using historical concepts alongside the user relationship matrices. The user relationship matrices provide personalized insights into how different users interact with and relate to various concepts. By integrating these matrices, the model can learn to adjust its summarization strategies to reflect the preferences and interaction patterns of individual users. This might involve emphasizing certain aspects of a concept more than others or altering the style and tone of the summary to better engage with the user based on their previous interactions.

During this training phase, the model processes both the content of the historical concepts and the data from the user relationship matrices. It learns to recognize and incorporate user-specific nuances into the generated summaries. This training is iterative, with the model continuously adjusting its parameters to improve the relevance and personalization of the summaries based on feedback loops that assess the accuracy and engagement level of the summaries. Ultimately, this retrained or fine-tuned model becomes capable of generating contextually relevant summaries that are not just factually accurate but are also tailored to meet the specific needs and preferences of users, enhancing the relevance and usefulness of the content delivered to each user.

In some embodiments, the system may determine a first user profile characteristic of the first user and select a first language model from a plurality of language models based on the first user profile characteristic. For example, the system may determine a key user profile characteristic of the first user. This characteristic could be derived from a variety of data sources, including user-provided information during sign-up (like age, profession, and educational background), behavioral data collected over time (such as content preferences, interaction patterns, and engagement metrics), or even inferred data through analysis of social interactions and external databases. For example, if a user frequently reads and interacts with scientific articles, the system might infer a preference for detailed, technical content. Once a significant characteristic—or a set of characteristics—has been identified, the system then reviews its available language models. Each model in the plurality might be specialized to better serve different user segments. For example, some models could be trained on academic or technical language suited for professionals and scholars, while others might be optimized for more casual, conversational content preferred by a broader audience.

The selection process may involve matching the identified user profile characteristics with the language model that best aligns with that profile. If the user's profile indicates a preference for concise and straightforward summaries, the system would select a model trained to produce content that emphasizes clarity and brevity. Conversely, if the profile suggests a penchant for in-depth analysis, the system may choose a model that excels in generating detailed and expansive summaries. This targeted selection of a language model based on user characteristics allows the system to tailor its content generation more effectively, enhancing user satisfaction and engagement. By dynamically aligning the content generation process with individual user needs, the system can deliver a highly personalized user experience that is responsive to the unique preferences and expectations of each user. This approach not only improves the relevance of the content but also fosters a more engaging and satisfying interaction with the platform.

In some embodiments, the second artificial intelligence model may be further trained to generate contextually relevant summaries on the inputted concepts and the inputted user relationship matrices by determining a training parameter for the first language model, adjusting the training parameter based on the inputted user relationship matrices, and retraining the first language model to modify the summaries to generate contextually relevant summaries after adjusting the training parameter. For example, the system may determine the appropriate training parameters for the first language model. These parameters might include learning rate, batch size, number of epochs, and specific weights or biases within the neural network architecture. These are crucial for controlling how the model learns from the training data, influencing everything from the speed of learning to the model's ability to generalize from its training to new, unseen data. Once the initial parameters are set, the next step involves adjusting these parameters based on the inputted user relationship matrices. This adjustment is pivotal as it allows the model to become more sensitive and responsive to the nuances captured in these matrices, which reflect how different users relate to various concepts. For example, if the user relationship matrices indicate that a user has a strong preference for detailed analysis in certain areas, the training parameters might be adjusted to prioritize depth over breadth in content summarization in those areas. The retraining of the first language model with these adjusted parameters is where the model starts to generate summaries that are not only accurate but also tailored to the context of individual user preferences. This involves feeding the model with a dataset of content and corresponding summaries, along with the user relationship matrices that provide a layer of user-specific context. During training, the model learns to adjust its summarization tactics based on both the content and the insights from the matrices, refining its output to better align with what is known about each user's preferences and interests. The final output, after this comprehensive training process, is a model capable of producing contextually relevant summaries. These summaries are not generic; they are customized dynamically to resonate more profoundly with the user based on their historical interactions and demonstrated interests as documented in the user relationship matrices. This approach ensures that the summaries are not only informative but also engaging and relevant, enhancing user satisfaction and the overall user experience with the platform.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for summarizing contextually relevant information on user-selected concepts based on relationships of users using language models.
2. The method of the preceding embodiment, further comprising: receiving, at a user interface, a first user query, from a first user, for a first contextually relevant summary of a first concept based on data from a first data store; selecting a first concept identifier from of a plurality of concept identifiers corresponding to the first concept; in response to selecting the first concept identifier, generating a first feature input for a first artificial intelligence model, wherein the first artificial intelligence model is trained to map a plurality of user interactions to inputted concept identifiers to determine user relationship matrices for the inputted concept identifiers; inputting the first feature input into the first artificial intelligence model to generate a first output, wherein the first output comprises a first user relationship matrix for the first user and the first concept; in response to receiving the first user relationship matrix, generating a second feature input for a second artificial intelligence model based on the first concept and the first user relationship matrix, wherein the second artificial intelligence model is trained to generate contextually relevant summaries on inputted concepts and inputted user relationship matrices; inputting the second feature input into the second artificial intelligence model to generate a second output, wherein the second output comprises the first contextually relevant summary of the first concept; and generating for display, in the user interface, the first contextually relevant summary.
3. The method of any one of the preceding embodiments, wherein the first artificial intelligence model is trained to map the plurality of user interactions to the inputted concept identifiers to determine the user relationship matrices for the inputted concept identifiers by: retrieving a plurality of user interaction reports corresponding to the plurality of user interactions; and iteratively parsing the plurality of user interaction reports for the first concept identifier to determine one or more relationships between the first user and the first concept.
4. The method of any one of the preceding embodiments, wherein the first artificial intelligence model is further trained to map the plurality of user interactions to the inputted concept identifiers to determine the user relationship matrices for the inputted concept identifiers by: determining characteristics of the one or more relationships; and weighting each of the one or more relationships based on the characteristics.
5. The method of any one of the preceding embodiments, wherein determining the characteristics of the one or more relationships further comprises: determining respective strengths of the one or more relationships; and determining respective characteristics based on the respective strengths.
6. The method of any one of the preceding embodiments, wherein determining the characteristics of the one or more relationships further comprises: determining respective frequencies of the one or more relationships; and determining respective characteristics based on the respective frequencies.
7. The method of any one of the preceding embodiments, wherein determining the characteristics of the one or more relationships further comprises: determining respective uniqueness of each of the one or more relationships; and determining respective characteristics based on the respective uniqueness of each of the one or more relationships.
8. The method of any one of the preceding embodiments, wherein generating the first output further comprises: determining a plurality of relationships between a first set of user interactions of the first user and the first concept identifier; and generating the first user relationship matrix for the first user based on the plurality of relationships.
9. The method of any one of the preceding embodiments, wherein generating the first output further comprises: determining a plurality of weights between a first set of user interactions of the first user and the first concept identifier; and generating the first user relationship matrix for the first user based on the plurality of weights.
10. The method of any one of the preceding embodiments, wherein the second artificial intelligence model is trained to generate the contextually relevant summaries on the inputted concepts and the inputted user relationship matrices by: retrieving a plurality of historical concepts; and retrieving a first language model trained to generate summaries of the plurality of historical concepts in the first data store.
11. The method of any one of the preceding embodiments, further comprising: determining a first user profile characteristic of the first user; and selecting the first language model from a plurality of language models based on the first user profile characteristic.
12. The method of any one of the preceding embodiments, wherein the second artificial intelligence model is further trained to generate the contextually relevant summaries on the inputted concepts and the inputted user relationship matrices by: determining a training parameter for the first language model; adjusting the training parameter based on the inputted user relationship matrices; and retraining the first language model to modify the summaries to generate the contextually relevant summaries after adjusting the training parameter.
13. The method of any one of the preceding embodiments, further comprising: determining a modification to the plurality of user interactions mapped to the inputted concept identifiers based on the first output; and re-training the first artificial intelligence model based on the modification.
14. The method of any one of the preceding embodiments, wherein the plurality of user interactions mapped to the inputted concept identifiers comprises a list of database links between the plurality of user interactions and the plurality of concept identifiers corresponding to the first concept.
15. The method of any one of the preceding embodiments, further comprising: determining a new database link based on the first output; and updating the list to include the new link.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for summarizing contextually relevant information on user-selected concepts based on relationships of users using language models with a divergent architecture, the system comprising:
one or more processors; and
one or more computer-readable mediums comprising instructions recorded thereon that when executed by the one or more processors cause operations comprising:
receiving, at a user interface, a first user query, from a first user, for a first contextually relevant summary of a first concept based on data from a first data store;
selecting a first concept identifier from of a plurality of concept identifiers corresponding to the first concept;
in response to selecting the first concept identifier, generating a first feature input for a first artificial intelligence model, wherein the first artificial intelligence model is trained to map a plurality of user interactions to inputted concept identifiers to determine user relationship matrices for the inputted concept identifiers by:
retrieving a plurality of user interaction reports corresponding to the plurality of user interactions;
iteratively parsing the plurality of user interaction reports for the first concept identifier to determine one or more relationships between the first user and the first concept; and
weighting each of the one or more relationships based on detected characteristics;
inputting the first feature input into the first artificial intelligence model to receive a first output, wherein the first output comprises a first user relationship matrix for the first user and the first concept;
in response to receiving the first user relationship matrix, generating a second feature input for a second artificial intelligence model based on the first concept and the first user relationship matrix, wherein the second artificial intelligence model is trained to generate contextually relevant summaries on inputted concepts and inputted user relationship matrices by:
retrieving a plurality of historical concepts;
retrieving a language model trained to generate summaries of the plurality of historical concepts in the first data store;
re-training the language model to modify the summaries to generate the contextually relevant summaries based on the inputted user relationship matrices;
inputting the second feature input into the second artificial intelligence model to receive a first output, wherein the first output comprises the first contextually relevant summary of the first concept; and
generating for display, in the user interface, the first contextually relevant summary.

2. A method for summarizing contextually relevant information on user-selected concepts based on relationships of users using language models, the method comprising:
receiving, at a user interface, a first user query, from a first user, for a first contextually relevant summary of a first concept based on data from a first data store;
selecting a first concept identifier from of a plurality of concept identifiers corresponding to the first concept;
in response to selecting the first concept identifier, generating a first feature input for a first artificial intelligence model, wherein the first artificial intelligence model is trained to map a plurality of user interactions to inputted concept identifiers to determine user relationship matrices for the inputted concept identifiers;
inputting the first feature input into the first artificial intelligence model to generate a first output, wherein the first output comprises a first user relationship matrix for the first user and the first concept;
in response to receiving the first user relationship matrix, generating a second feature input for a second artificial intelligence model based on the first concept and the first user relationship matrix, wherein the second artificial intelligence model is trained to generate contextually relevant summaries on inputted concepts and inputted user relationship matrices;
inputting the second feature input into the second artificial intelligence model to generate a second output, wherein the second output comprises the first contextually relevant summary of the first concept; and
generating for display, in the user interface, the first contextually relevant summary.

3. The method of claim 2, wherein the first artificial intelligence model is trained to map the plurality of user interactions to the inputted concept identifiers to determine the user relationship matrices for the inputted concept identifiers by:
retrieving a plurality of user interaction reports corresponding to the plurality of user interactions; and
iteratively parsing the plurality of user interaction reports for the first concept identifier to determine one or more relationships between the first user and the first concept.

4. The method of claim 3, wherein the first artificial intelligence model is further trained to map the plurality of user interactions to the inputted concept identifiers to determine the user relationship matrices for the inputted concept identifiers by:
determining characteristics of the one or more relationships; and
weighting each of the one or more relationships based on the characteristics.

5. The method of claim 4, wherein determining the characteristics of the one or more relationships further comprises:
determining respective strengths of the one or more relationships; and
determining respective characteristics based on the respective strengths.

6. The method of claim 4, wherein determining the characteristics of the one or more relationships further comprises:
determining respective frequencies of the one or more relationships; and
determining respective characteristics based on the respective frequencies.

7. The method of claim 4, wherein determining the characteristics of the one or more relationships further comprises:
determining respective uniqueness of each of the one or more relationships; and
determining respective characteristics based on the respective uniqueness of each of the one or more relationships.

8. The method of claim 2, wherein generating the first output further comprises:
determining a plurality of relationships between a first set of user interactions of the first user and the first concept identifier; and
generating the first user relationship matrix for the first user based on the plurality of relationships.

9. The method of claim 2, wherein generating the first output further comprises:
determining a plurality of weights between a first set of user interactions of the first user and the first concept identifier; and
generating the first user relationship matrix for the first user based on the plurality of weights.

10. The method of claim 2, wherein the second artificial intelligence model is trained to generate the contextually relevant summaries on the inputted concepts and the inputted user relationship matrices by:
retrieving a plurality of historical concepts; and
retrieving a first language model trained to generate summaries of the plurality of historical concepts in the first data store.

11. The method of claim 10, further comprising:
determining a first user profile characteristic of the first user; and
selecting the first language model from a plurality of language models based on the first user profile characteristic.

12. The method of claim 10, wherein the second artificial intelligence model is further trained to generate the contextually relevant summaries on the inputted concepts and the inputted user relationship matrices by:
determining a training parameter for the first language model;
adjusting the training parameter based on the inputted user relationship matrices; and
re-training the first language model to modify the summaries to generate the contextually relevant summaries after adjusting the training parameter.

13. The method of claim 2, further comprising:
determining a modification to the plurality of user interactions mapped to the inputted concept identifiers based on the first output; and
re-training the first artificial intelligence model based on the modification.

14. The method of claim 2, wherein the plurality of user interactions mapped to the inputted concept identifiers comprises a list of database links between the plurality of user interactions and the plurality of concept identifiers corresponding to the first concept.

15. The method of claim 14, further comprising:
determining a new database link based on the first output; and
updating the list to include the new link.

16. One or more non-transitory, computer-readable mediums, comprising instructions that, when executed by one or more processors, cause operations comprising:
identify, in a first text string, a first concept identifier of a plurality of concept identifiers, wherein the first concept identifier corresponds to a first concept of a plurality of entities;
in response to identifying the first concept identifier, generating a first feature input for a first artificial intelligence model, wherein the first artificial intelligence model is trained to generate a ranked mapping of the plurality of entities to a plurality of documents;
inputting the first feature input into the first artificial intelligence model to receive a first output, wherein the first output comprises a first document identifier for a first document from the plurality of documents corresponding to the first concept identifier that is determined to have a first rank based on one or more ranking criteria; and
generating for display, in a user interface, the first text string with a first annotation comprising the first document identifier for the first document and the first rank.

17. The one or more non-transitory, computer-readable mediums of claim 16, wherein the first artificial intelligence model is trained to generate the ranked mapping of the plurality of entities to the plurality of documents by:
retrieving the plurality of concept identifiers;
retrieving the plurality of documents from a documentation source;
iteratively parsing one of the plurality of documents for one of the plurality of concept identifiers; and
in response to detecting the one of the plurality of concept identifiers in the one of the plurality of documents, generating second feature inputs for the second artificial intelligence model to generate second outputs.

18. The one or more non-transitory, computer-readable mediums of claim 16, further comprising:
receiving a ranking criterion; and
generating a second feature input for a second artificial intelligence model to generate a second output, wherein the first artificial intelligence model is trained to generate the ranked mapping of the plurality of entities to a plurality of documents using a second artificial intelligence model that is trained to generate additional queries to run on the plurality of documents to determine rankings for the plurality of documents, and wherein the second artificial intelligence model comprises a language model trained to generate an additional query to be run on the one of the plurality of documents, and wherein the additional query is generated based on the ranking criterion and the first concept identifier.

19. The one or more non-transitory, computer-readable mediums of claim 16, wherein generating the first feature input for the first artificial intelligence model comprises:
determining the first concept corresponding to the first concept identifier; and
retrieving a subset of the plurality of concept identifiers for the first concept.

20. The one or more non-transitory, computer-readable mediums of claim 16, wherein generating the ranked mapping of the plurality of entities to the plurality of documents further comprises:
determining a subset of the plurality of documents that corresponds to the first concept; and
ranking each document in the plurality of documents.
